(19) United States
(12) Patent Application Publication
(10) Pub. No.: US 2006/0075734 A1
(43) Pub. Date: Apr. 13, 2006

(54) Header for a harvesting machine

(76) Inventor: Dominik Buermann, Verl (DE)

Correspondence Address: STRIKER, STRIKER & STENBY, 103 EAST NECK ROAD, HUNTINGTON, NY, 11743, US

(21) Appl. No.: 11/220,103

(22) Filed: Sep. 6, 2005

(30) Foreign Application Priority Data
Sep. 7, 2004 (DE) 10 2004 043 613.4

(51) Int. Cl. A01D 34/30

(52) U.S. Cl. 56/257

(57) ABSTRACT

A header for a self-propelled harvesting machine has at least one cutting unit, a drive which drives the cutting unit so that the cutting unit cuts crops from a field in a working width, the working width of the cutting unit being substantially equal to a width of the header.

### BACKGROUND OF THE INVENTION

The present invention relates to a header for a self-propelled harvesting machine, preferably a combine harvester.

A header for a combine harvester is disclosed in EP 0 789 990, in the case of which the drive elements for the cutter bar sections, the reel and the header auger are contained in a housing located on the outside of the side wall of the cutting table. A divider is located on the cutting table in the front region of the side wall. In a front region, the housing is nearly as wide as the divider. In the region of the cutter bar drive, the width of the housing increases in the manner of a wedge and subsequently extends—in its full, final width—parallel to the side wall in the rear region of the cutting table.

The disadvantage of this known header is that the location of the cutter bar drives requires that the housing have a wide shape. The part of the housing extending over the divider presses the crops outwardly out of the way. As a result, the plants are pressed to the ground, and crop kernels become detached from the plants due to the unintended moving of the stand and are lost due to breakage.

### SUMMARY OF THE INVENTION

The object of the present invention, therefore, is to create a header that avoids the disadvantages of the related art and permits a narrow design of the divider due to a space-saving arrangement of the cutter bar drive, while retaining the cutting width, so that fewer crops are pressed toward the ground by the divider.

In keeping with these objects and with others which will become apparent hereinafter, one feature of the present invention resides, briefly stated, in header for a self-propelled harvesting machine, comprising at least one cutting unit; a drive which drives said cutting unit so that said cutting unit cuts crops from a field in a working width, said working width of said cutting unit being substantially equal to a width of the header.

The fact that the working width of the cutting unit is essentially the same as the width of the header ensures that the header overhangs only slightly on the side. This has the advantage, in particular, that the stand of crops surrounding the cutting unit is pressed to the ground with lesser intensity, thereby greatly reducing the loss due to breakage.

Due to the fact that the drive of the at least one cutting unit is located above the cutting unit and substantially within the working width of the cutting unit, the divider can be designed narrower in shape.

Due to the fact that the header includes a cutting table with at least two side walls, and, at the least, the side wall facing the cutting unit has an offset, the divider can be designed narrower in shape while the cutting width is increased.

Advantageously, the offset is designed as a material-guiding element, so that the crops are directed toward the middle of the cutting table and the sliding motion of the crops in this direction is promoted.

In an advantageous embodiment of the present invention, the side wall includes a front side wall element and a rear side wall element, the front side wall element limiting the working width, and the rear side wall element limiting a feed width, and the offset constricting the side wall from the working width to the feed width, so that the crop flow is funneled more closely together by the side wall.

Due to the fact that the cutting unit is designed as a cutter bar section and is located in the front region of the cutting table—with the offset being located in the region of the cutter bar section—the knife drive can be located in the immediate vicinity of the cutter bar section and drive the cutter bar section directly without the use of any intermediately-connected drive elements.

In an advantageous embodiment of the present invention, the cutting table has a header trough, and a header auger is located above the header trough, the offset being slanted in the direction of the header auger, so that crops cut by the cutter bar are funneled more closely together in a non-destructive manner and fall in the direction of the header trough.

In a further advantageous embodiment of the present invention, the drive is located on the outside of the side wall in a housing, and the housing has a first width in the region of the front side wall element and a second width in the region of the rear side wall element, the second width being greater than the first width, so that housing is matched to the size and location of the drive and has the narrowest configuration possible, at least in the region of the divider.

In an advantageous further development of the present invention, the housing is closable with a cover that extends parallel to the direction of travel of the harvesting machine, and, in the front region of the housing, a divider point is located on the cutting table, the divider point terminating nearly flush with the front side wall element and the cover, and being located within the lines of extension of the front side wall element and the cover, so that the housing, together with the divider point, results in a divider that redirects the crops only in the region of the divider point.

The novel features which are considered as characteristic for the present invention are set forth in particular in the appended claims the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows the front part of a top view of a schematically depicted combine harvester with a header according to the present invention,

FIG. 2 shows a perspective view of a header according to the present invention.

### DESCRIPTION OF THE PREFERRED EMBODIMENTS

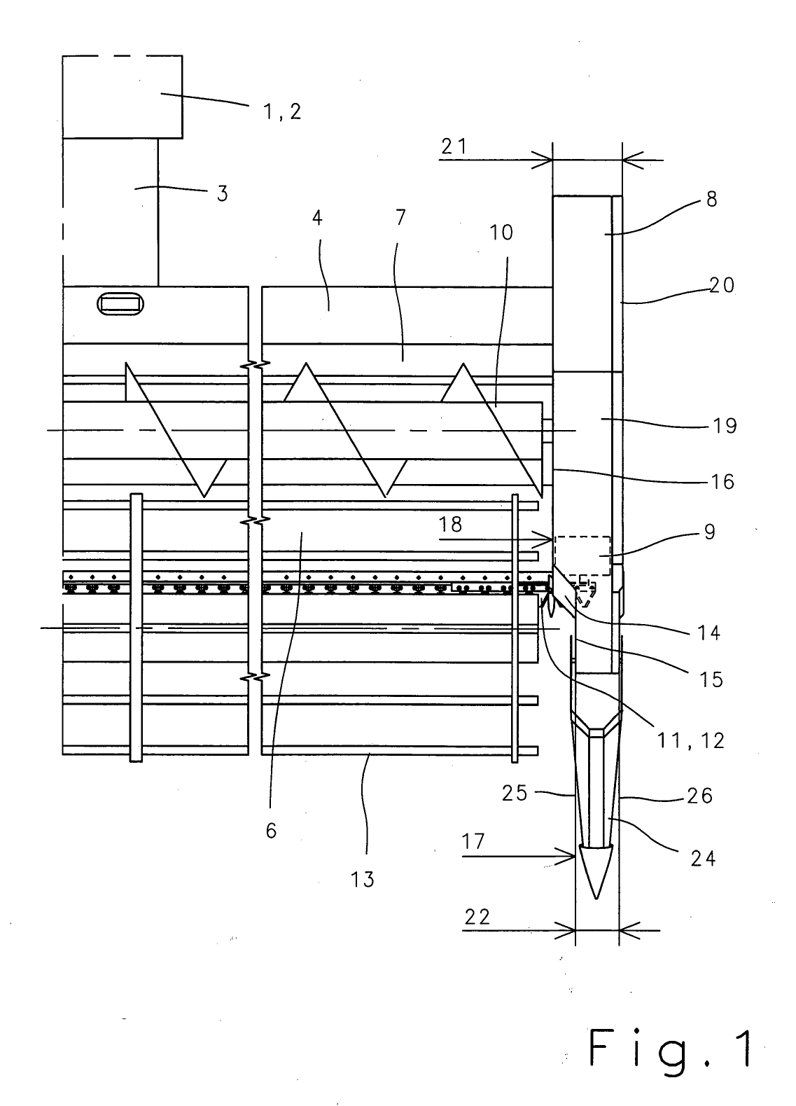

FIG. 1 shows a portion of the top view of an agricultural harvesting machine 2 designed as a self-propelled combine harvester 1, on the feed rake 3 of which a header 4 is located.

Header 4 is composed essentially of a cutting table 6 with a header trough 7 that is provided with a side wall 8 at both ends. A rotatably driven header auger 10 is located above header trough 7 and is nearly flush between side walls 8. The crops are cut by two cutting units 11 designed as cutter bar sections 12 driven in an oscillating manner and located in the front region of header 6, and are subsequently fed to header auger 10, which conveys the crops to feed rake 3. It is also within the scope of the present invention for only one cutter bar section 12 to be assigned to header 6. A rotatably driven, height-adjustable reel 13 is located above cutting table 6 in front of header auger 10, with which the crops are redirected via cutter bar sections 12 in the direction of header trough 7. The description below refers to one half of symmetrically-designed header 4.

In the region of cutter bar section 12, side wall 8 includes an offset 14 designed as a material-guiding element, offset 14 interconnecting a front side wall element 15 of side wall 8 and a rear side wall element 16 of side wall 8 that is offset inwardly relative to the former. Front side wall element 15 and rear side wall element 16 extend parallel to the direction of travel of combine harvester 1.

Front side wall element 15 limits a working width 17 of header 4 within which the crops are harvested from the field. Offset 14 extends from front side wall element 15 diagonally inwardly to rear side wall element 16, so that working width 17 is reduced to a feed width 18 that is limited by rear side wall elements 16. The crops cut by cutter bar sections 12 are therefore funneled together by offset 14 into feed width 18.

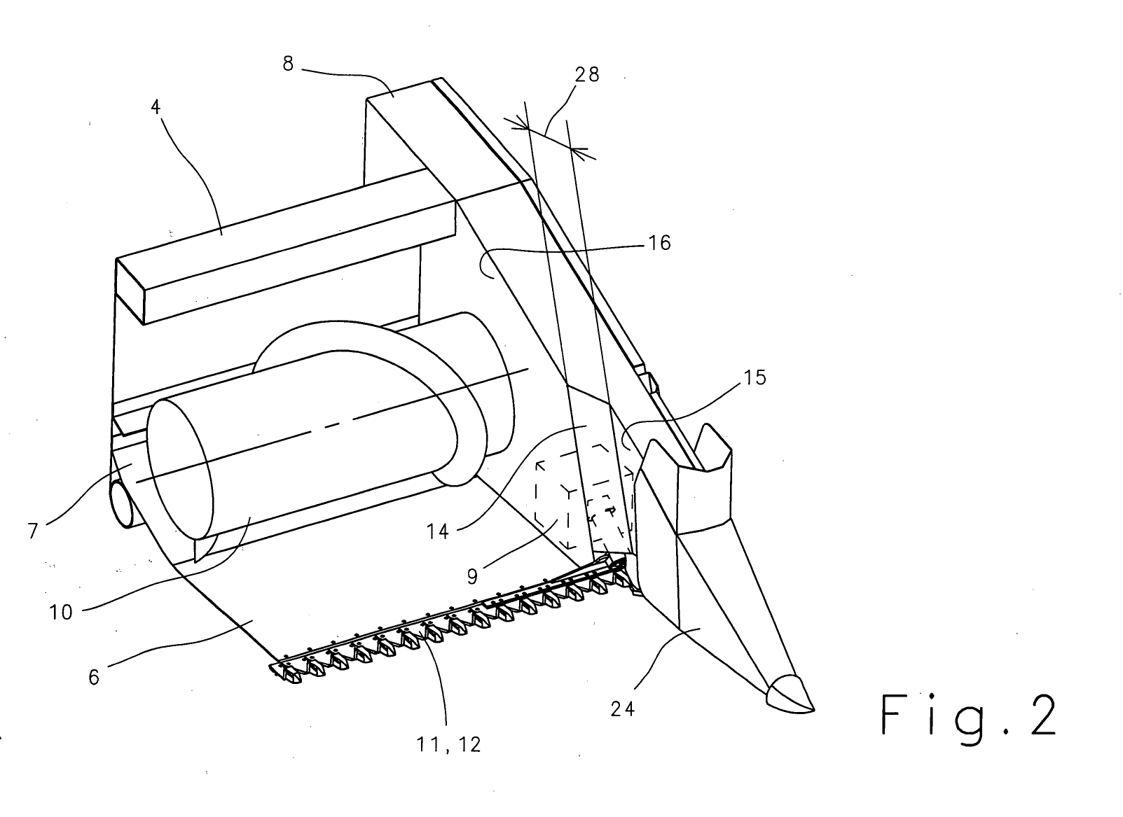

A housing 19 is located on the outside of side wall 8 of cutting table 6, housing 19 being closed by a cover 20, and cover 20 also extending parallel to the direction of travel of combine harvester 1. Among other things, drive 9 for cutter bar section 12 is located inside housing 19. Due to offset 14, housing 19 has a first width 21 in the region of the front side wall 15 and a second width 22 in the region of the rear side wall 15, second width 22 being greater than first width 21, so that drive 9 can be located—according to the present invention—substantially within working width 17 of cutting unit 11 and, as shown in FIG. 2, above cutting unit 11 in a space-saving manner in the immediate vicinity of cutting unit 11. A divider point 24 is located on cutting table 6 in the front region of housing 19, which terminates nearly flush with front side wall element 15 and cover 20 and thereby is located within the lines of extension 25, 26 of front side wall element 15 and cover 20.

FIG. 2 shows a perspective view of header 4 according to the present invention. Offset 14 is slanted in the direction of header auger 10, extends along the entire side wall 8, and has a nearly constant width 28. Front side wall element 15 is located mainly in the region in front of cutter bar section 12 and partially above cutter bar section 12, while rear side wall element 16 is located only behind cutter bar section 12.

It will be understood that each of the elements described above, or two or more together, may also find a useful application in other types of constructions differing from the types described above.

While the invention has been illustrated and described as embodied in a header for a harvesting machine, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A header for a self-propelled harvesting machine, comprising at least one cutting unit; a drive which drives said cutting unit so that said cutting unit cuts crops from a field in a working width, said working width of said cutting unit being substantially equal to a width of the header.

2. A header as defined in claim 1, wherein said drive of said at least one cutting unit is located above said cutting unit and substantially within said working width of said cutting unit.

3. A header as defined in claim 1; and further comprising a cutting table with at least two side walls, at least one of said side walls facing said cutting unit having an offset.

4. A header as defined in claim 3, wherein said offset of said at least one side wall is configured as a material-guiding element.

5. A header as defined in claim 3, wherein said at least one side wall includes a front side wall element and a rear side wall element, said front side wall element limiting said working width of said cutting unit, said rear side wall element limiting a feed width of said cutting table, and said offset reducing said at least one side wall from said working width to said feed width.

6. A header as defined in claim 3, wherein said at least one cutting unit is configured as a cutter bar section and located in a front region of said cutting table, said offset being located in a region of said cutter bar section.

7. A header as defined in claim 3, wherein said cutting table includes a header trough, and a header auger located above said header trough, said offset being slanted in a direction of said header auger.

8. A header as defined in claim 1; and further comprising a cutting table having at least two side walls, at least one of said side walls having an offset, and a front side wall element and a rear side wall element; and a housing, said drive being located on an outside of said at least one side wall in said housing, said housing having a first width defined by said offset in a region of said front side wall element and a second width at least in a region of said rear side wall element, said second width being greater than said first width.

9. A header as defined in claim 1; and further comprising a cutting table having at least two side walls with at least one of said side walls having a front side wall element and a rear side wall element; and a housing closable with a cover, said cover extending parallel to a direction of travel of the harvesting machine, said cutting table having a divider point located in a front region of said housing and terminating substantially flush with said front side wall element and said cover, and being located within lines of extension of said front side wall element and said cover.
